(19) United States
(12) Patent Application Publication
(10) Pub. No.: US 2010/0045647 A1
(43) Pub. Date: Feb. 25, 2010

(54) DRIVING CIRCUIT FOR BACKLIGHT UNIT HAVING RESET FUNCTION

(75) Inventors: Jin Hwan Kim, Suwon (KR); Jong Rak Kim, Suwon (KR); Young Jong Yoo, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/342,175

(22) Filed: Dec. 23, 2008

(30) Foreign Application Priority Data
Aug. 25, 2008 (KR) 10-2008-0083073

(51) Int. Cl. G06F 3/038

(52) U.S. Cl. 345/211

(57) ABSTRACT

There is provided a driving circuit for a backlight unit having a reset function to prevent a malfunction of an apparatus caused by electrical stress such as ESD/EOS. A driving circuit for a backlight unit according to an aspect of the invention may include: a power supply section supplying driving power; a control section receiving the driving power from the power supply section to control the luminance of lamps; and a reset section detecting a voltage level of a luminance control signal from the control section to reset the driving power supplied to the control section when the control section malfunctions.

### CROSS-REFERENCE TO RELATED APPLICATIONS

This application claims the priority of Korean Patent Application No. 2008-0083073 filed on Aug. 25, 2008, in the Korean Intellectual Property Office, the disclosure of which is incorporated herein by reference.

### BACKGROUND OF THE INVENTION

1. Field of the Invention

The present invention relates to driving circuits for backlight units, and more particularly, to a driving circuit for a backlight unit having a reset function to prevent a malfunction of an apparatus caused by electrical stress such as ESD/EOS.

2. Description of the Related Art

Recently, among display devices, liquid crystal displays (LCDs) have been used in various kinds of products including computers, notebook computers, and AV devices, since they have advantages such as small size, light weight and low power consumption.

Backlight units that emit light necessary for pixels are used in these LCDs.

Each of the backlight units includes a plurality of bar-shaped lamps, a power supply circuit supplying power to the lamps and driving power to another circuit, and a control unit receiving the driving power to control the luminance of each lamp.

Cold cathode fluorescent lamps (CCFLs) are generally used as the above lamps. However, backlight units using light emitting diodes as light sources have appeared in consideration of processing speed, power consumption and life.

The backlight unit using the light emitting diodes as light sources includes a driving circuit to control the light emitting diodes. The above-described driving circuit uses a control section formed of a field-programmable gate array (FPGA) to perform local dimming and scanning dimming. The driving circuit having the FPGA can maximize a contrast ratio and effectively remove an afterimage of a moving image.

However, the control section formed of the FPGA is susceptible to electrical stress such as electro-static discharge (ESD) or electrical over stress (EOS). When the electrical stress is applied to the control section, a failure occurs in the control section.

### SUMMARY OF THE INVENTION

An aspect of the present invention provides a driving circuit for a backlight unit having a reset function to prevent a malfunction of an apparatus caused by electrical stress such as ESD/EOS.

According to an aspect of the present invention, there is provided a driving circuit for a backlight unit, the driving circuit including: a power supply section supplying driving power; a control section receiving the driving power from the power supply section to control the luminance of lamps; and a reset section detecting a voltage level of a luminance control signal from the control section to reset the driving power supplied to the control section when the control section malfunctions.

The reset section may include: a detection unit detecting whether a signal level of the luminance control signal from the control section is within a predetermined level range; and a reset control unit cutting off supply of the driving power for a predetermined period of time when a result of the detection from the detection unit indicates a malfunction.

The detection unit may include: a first comparator having a first plus input terminal receiving a predetermined first reference voltage and a first minus input terminal receiving the luminance control signal; and a second comparator having a second plus input terminal receiving the luminance control signal and a second minus input terminal receiving a second reference voltage having a higher voltage level than the first reference voltage.

The reset section further may include a switch unit switching bias power having a predetermined voltage level from the power supply section and transmitting a high-level signal when a result of the detection from the detection unit indicates a malfunction, and the switch unit may include: a first switch switched on to open a path through which the bias power is transmitted to a ground; and a second switch blocking the path through which the bias power is transmitted to the ground and transmitting a high-level signal to the reset control unit when the first switch is switched on.

The reset control unit may include: a pulse generator outputting a pulse signal having a predetermined time duration when the high-level signal is transmitted from the second switch; and a third switch cutting off supply of the driving power during a time when the pulse signal from the pulse generator maintains a high level.

The control section may include: a main controller outputting a pulse width modulation (PWM) luminance control signal to perform local control of the luminance of the lamps and a linear luminance control signal to determine a signal level of the PWM luminance control signal; and an auxiliary controller outputting a PWM luminance control signal to perform local control of the luminance of the lamps.

The main controller may transmit a predetermined pulse signal to the auxiliary controller, and output the linear luminance control signal when receiving a response signal to the pulse signal from the auxiliary controller.

The control section further may include a filter for filtering the linear luminance control signal from the main controller to transmit the filtered luminance control signal to the detection unit of the reset section.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating a configuration of a driving circuit for a backlight unit according to an exemplary embodiment of the invention; and

FIG. 2 is a detailed view illustrating a reset section used in a driving circuit for a backlight unit according to an exemplary embodiment of the invention.

### DETAILED DESCRIPTION OF THE PREFERRED EMBODIMENT

Exemplary embodiments of the present invention will now be described in detail with reference to the accompanying drawings.

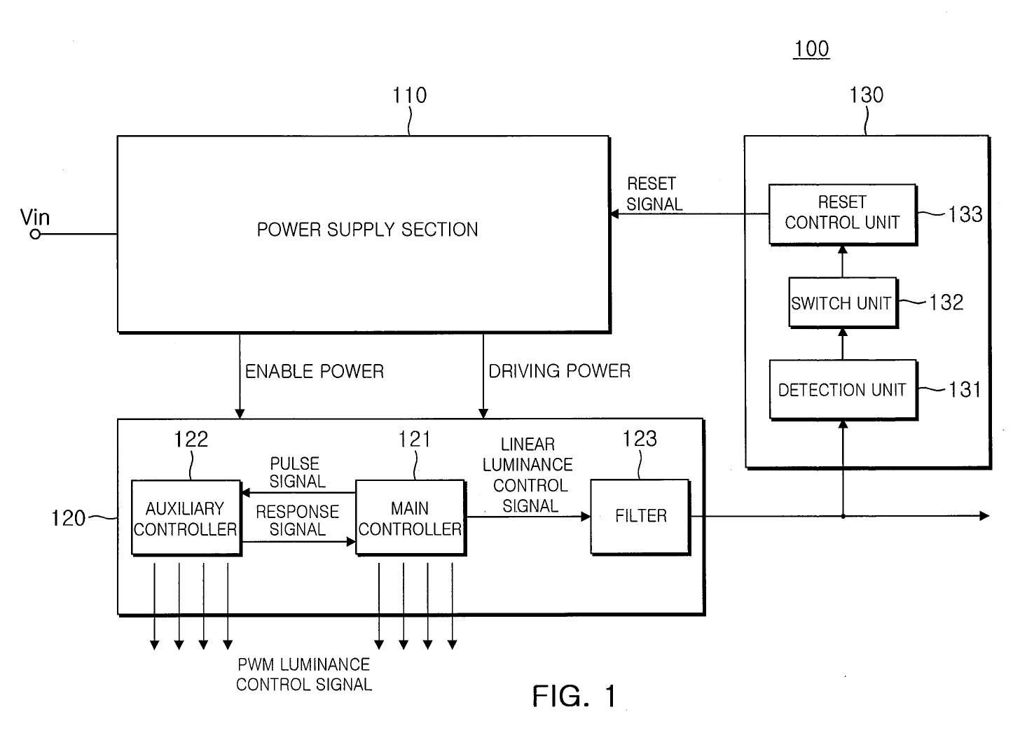

FIG. 1 is a schematic view illustrating a configuration of a driving circuit for a backlight unit according to an exemplary embodiment of the invention.

Referring to FIG. 1, a driving circuit 100 for a backlight unit according to an exemplary embodiment of the invention includes a power supply section 110, a control section 120, and a reset section 130.

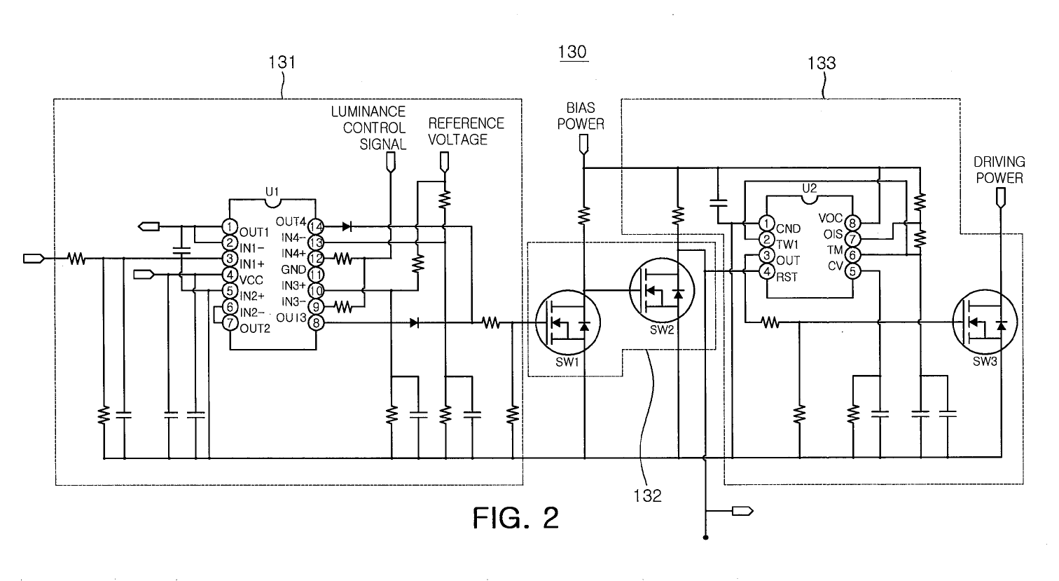

The power supply section 110 converts input power Vin into a plurality of powers having different voltage levels. That is, the power supply section 110 may output enable power and driving power having different voltage levels. As shown in FIG. 2, the power supply section 110 may output bias power.

The enable power and the driving power from the power supply section 110 are transmitted to the control section 120.

The control section 120 outputs a luminance control signal to control the luminance of lamps. Here, when the enable power from the power supply section 110 has a high voltage level, the control section 120 starts to operate, and performs the luminance control operation when receiving the driving power required to perform this operation.

The control section 120 can perform local luminance control so that the luminance of some of the plurality of lamps can be controlled. The control section 120 outputs a pulse width modulation (PWM) luminance control signal for the local luminance control and a linear luminance control signal to determine a level size of the PWM luminance control signal. Here, the linear luminance control signal means a current target value when the PWM luminance control signal has a duty cycle of 100%.

The control section 120 may include a main controller 121 and an auxiliary controller 122, and may also include a filter 123.

Each of the main controller 121 and the auxiliary controller 122 may be a digital integrated circuit (IC) formed of a field-programmable gate array (FPGA), and thus may be susceptible to electrical stress. The main controller 121 sends a pulse signal to the auxiliary controller 122 at regular time intervals. When the main controller 121 receives a response signal to the pulse signal from the auxiliary controller 122, the main controller 121 determines that the auxiliary controller 122 performs a normal operation, and then outputs the linear luminance control signal.

The linear luminance control signal is filtered through the filter 123 and sent to the reset section 130.

The reset section 130 may include a detection unit 131, a switch unit 132, and a reset control unit 133.

The detection unit 131 receives the luminance control signal from the filter 123 and detects whether the luminance control signal is normal or abnormal. That is, when the auxiliary controller 122 of the control section 120 malfunctions due to electrical stress, the main controller 121 does not output the linear luminance control signal. When a failure occurs in the main controller 121, the linear luminance control signal has a low or high voltage level.

Therefore, when the luminance control signal has a voltage level within a predetermined reference voltage range, the detection unit 131 determines that the control section 120 performs a normal operation. When the luminance control signal has a voltage level outside the reference voltage range, the detection unit 131 determines that a failure occurs in the control section 120, and detects whether the control section 120 malfunctions or not.

When a detection result from the detection unit 131 indicates a malfunction, the switch unit 132 switches the bias power from the power supply section 110 to output a high-level signal. On the other hand, when the detection result indicates a normal operation, the switch unit 132 outputs a low-level signal.

When the reset control unit 133 receives the high-level signal from the switch unit 132, the reset control unit 133 cuts off supply of the driving power for a predetermined period of time to reset the control section 120.

FIG. 2 is a detailed view illustrating a reset section used in a driving circuit for a backlight unit according to an exemplary embodiment of the invention.

Referring to FIGS. 1 and 2, the detection unit 131 may include a first IC U1 having first and second comparators. For example, the detection unit 131 may be formed of an LM324 IC.

The first IC U1 may have fourteen terminals and four comparators. Among them, two of the comparators corresponding to first through seventh terminals located on the left side of the first IC U1 may form a predetermined buffer circuit, and an internal circuit corresponding to eighth to fourteenth terminals located on the right side of the first IC U1 may form the first and second comparators. A first reference voltage of approximately 1.0V is supplied to the tenth terminal, which is a plus terminal of the first comparator. A second reference voltage of approximately 3.0V is supplied to the thirteenth terminal, which is a minus terminal of the second comparator. The voltage level of the luminance control signal from the control section 120 is input to each of the ninth terminal, which is a minus terminal of the first comparator, and the twelfth terminal, which is a plus terminal of the second comparator.

When the luminance control signal has a voltage level within the first reference voltage range and the second reference voltage range, it is determined that the control section 120 performs a normal operation. When the luminance control signal has a voltage level outside the first reference voltage range and the second reference voltage range, it is determined that the control section 120 performs an abnormal operation.

That is, the detection unit 131 detects whether a failure occurs in the control section 120, and transmits a detection result to the switch unit 132. Here, since the detection unit 131 includes the above-described first and second comparators, the detection result is output as a high-level signal when the control section 120 malfunctions.

The switch unit 132 receives bias power having a predetermined voltage level from the power supply section 110. The switch unit 132 includes first and second switches SW1 and SW2 that are connected in parallel between a bias power terminal and a ground terminal.

When the detection result from the detection unit 131 indicates a malfunction, that is, a high-level signal, the detection result is transmitted to a base of the first switch SW1. Then, the first switch SW1 is switched on to open a path through which the bias power is transmitted to the ground.

When the first switch SW1 is switched on, a low-level signal is transmitted to a base of the second switch SW2 such that the second switch SW2 is switched off to thereby block the path through which the bias power is transmitted to the ground. The second switch SW2 transmits the high-level signal to the reset control unit 133. The voltage level of the bias power may be equal to that of the high-level signal from the second switch SW2.

The reset control unit 133 includes a pulse generator U2 that outputs a predetermined pulse signal and a third switch SW3 that outputs a reset signal.

The pulse generator U2 outputs a pulse signal having a predetermined time duration when receiving the high-level signal from the second switch SW2. The pulse generator U2 may be formed of a 555 timer or an integrated circuit having eight terminals. The high-level signal from the second switch SW2 is input to a fourth terminal, and the pulse signal may be correspondingly output through a third terminal.

The third switch SW3 outputs a reset signal during a time when the pulse signal from the pulse generator U2 maintains a high level.

That is, when the pulse signal from the pulse generator U2 has a high level, the third switch SW3 cuts off the supply of the driving power supplied to the control section 120 from the power supply section 110 to thereby reset the control section 120.

As set forth above, according to an exemplary embodiment of the invention, a malfunction of a digital IC, such as an FPGA, can be prevented even when electrical stress is applied to a backlight unit.

While the present invention has been shown and described in connection with the exemplary embodiments, it will be apparent to those skilled in the art that modifications and variations can be made without departing from the spirit and scope of the invention as defined by the appended claims.

What is claimed is:

1. A driving circuit for a backlight unit, the driving circuit comprising:
a power supply section supplying driving power;
a control section receiving the driving power from the power supply section to control the luminance of lamps; and
a reset section detecting a voltage level of a luminance control signal from the control section to reset the driving power supplied to the control section when the control section malfunctions.

2. The driving circuit of claim 1, wherein the reset section comprises:
a detection unit detecting whether a signal level of the luminance control signal from the control section is within a predetermined level range; and
a reset control unit cutting off supply of the driving power for a predetermined period of time when a result of the detection from the detection unit indicates a malfunction.

3. The driving circuit of claim 2, wherein the detection unit comprises:
a first comparator having a first plus input terminal receiving a predetermined first reference voltage and a first minus input terminal receiving the luminance control signal; and
a second comparator having a second plus input terminal receiving the luminance control signal and a second minus input terminal receiving a second reference voltage having a higher voltage level than the first reference voltage.

4. The driving circuit of claim 3, wherein the reset section further comprises a switch unit switching bias power having a predetermined voltage level from the power supply section and transmitting a high-level signal when a result of the detection from the detection unit indicates a malfunction, and
the switch unit comprises:
a first switch switched on to open a path through which the bias power is transmitted to a ground; and
a second switch blocking the path through which the bias power is transmitted to the ground and transmitting a high-level signal to the reset control unit when the first switch is switched on.

5. The driving circuit of claim 4, wherein the reset control unit comprises:
a pulse generator outputting a pulse signal having a predetermined time duration when the high-level signal is transmitted from the second switch; and
a third switch cutting off supply of the driving power during a time when the pulse signal from the pulse generator maintains a high level.

6. The driving circuit of claim 1, wherein the control section comprises:
a main controller outputting a pulse width modulation (PWM) luminance control signal to perform local control of the luminance of the lamps and a linear luminance control signal to determine a signal level of the PWM luminance control signal; and
an auxiliary controller outputting a PWM luminance control signal to perform local control of the luminance of the lamps.

7. The driving circuit of claim 6, wherein the main controller transmits a predetermined pulse signal to the auxiliary controller, and outputs the linear luminance control signal when receiving a response signal to the pulse signal from the auxiliary controller.

8. The driving circuit of claim 6, wherein the control section further comprises a filter for filtering the linear luminance control signal from the main controller to transmit the filtered luminance control signal to the detection unit of the reset section.
